(19) United States
(12) Patent Application Publication
(10) Pub. No.: US 2017/0176399 A1
(43) Pub. Date: Jun. 22, 2017

(54) OBJECT INFORMATION ACQUIRING APPARATUS AND CONTROL METHOD THEREOF

(71) Applicant: CANON KABUSHIKI KAISHA, Tokyo (JP)

(72) Inventor: Shoya Sasaki, Yokohama-shi (JP)

(21) Appl. No.: 15/372,661

(22) Filed: Dec. 8, 2016

(30) Foreign Application Priority Data
Dec. 17, 2015 (JP) 2015-246618

(51) Int. Cl. G01N 29/30; G01B 17/00; G01N 29/24

(52) U.S. Cl. CPC G01N 29/30; G01N 29/2418; G01B 17/00

(57) ABSTRACT

An object information acquiring apparatus according to the present invention includes: a probe including a plurality of transducers that convert an acoustic wave from measurement object to an electrical signal; a positional information acquirer that acquires positional information on the transducers; and a characteristic information acquirer that acquires characteristic information on the measurement object, based on the electrical signal and the positional information, wherein the positional information acquirer acquires a first data group which is a distance between the first position and each of the plurality of transducers; calculates a second data group which is a distance between the point sound source and each of the plurality of transducers.

### BACKGROUND OF THE INVENTION

### Field of the Invention

The present invention relates to an object information acquiring apparatus and a control method thereof.

Description of the Related Art

In recent years, imaging of the inside of an object using photoacoustic imaging is being studied. Photoacoustic tomography (PAT) is a form of photoacoustic imaging.

When an object is irradiated with pulsed light generated by a light source, an acoustic wave is generated by tissue inside the object having absorbed optical energy. This phenomenon is called a photoacoustic effect. The generated acoustic wave is detected by transducers arranged in plurality around the object. In addition, information inside the object can be acquired by subjecting a received signal to signal processing. This is the principle of imaging by photoacoustic tomography.

For example, when near infrared light which is well absorbed by hemoglobin is used as pulsed light, imaging of hemoglobin or, in other words, sites where blood is present in the object can be performed. Use of a result of blood vessel imaging to the diagnosis of malignant tumors is expected.

U.S. Pat. No. 5,840,023 describes, as an example of imaging by photoacoustic tomography, a method of receiving an acoustic wave from an object while moving a light irradiating region and a transducer which receives an acoustic wave, and reconstructing object information.

Patent Literature 1: U.S. Pat. No. 5,840,023

### SUMMARY OF THE INVENTION

When performing image reconstruction using received signals received by a plurality of transducers, processing is performed based on a distance between a position of interest and each transducer. However, it is difficult to mechanically arrange a plurality of transducers with accuracy on a probe without affecting resolution of a reconstructed image. Therefore, there is a problem in that an error due to accuracy of mechanical arrangement causes a decline in the resolution of a reconstructed image.

The present invention has been made in consideration of the problem described above. An object of the present invention is to accurately calibrate positions of a plurality of transducers using received signals of the transducers.

The present invention provides an object information acquiring apparatus, comprising:

a plurality of transducers that receive an acoustic wave propagating from a measurement object irradiated with light and that convert the acoustic wave into an electrical signal;

a probe on which the plurality of transducers are arranged so that directivity axes of at least a part of the plurality of transducers converge;

a positional information acquirer that acquires positional information regarding positions of the plurality of transducers; and

a characteristic information acquirer that acquires characteristic information on the measurement object based on the electrical signal and the positional information, wherein

the positional information acquirer:

acquires, for a case where a point sound source is positioned at a first position at which the point sound source and the probe take predetermined relative positions, a first data group which is a distance between the first position and each of the plurality of transducers;

calculates, for a case where the measurement object is the point sound source, a second data group which is a distance between the point sound source and each of the plurality of transducers based on the electrical signal derived from the acoustic wave having actually propagated from the point sound source; and

calculates the positional information based on the first data group and the second data group.

The present invention also provides a control method for an object information acquiring apparatus including:

a plurality of transducers that receive an acoustic wave propagating from a measurement object irradiated with light and that convert the acoustic wave into an electrical signal;

a probe on which the plurality of transducers are arranged so that directivity axes of at least a part of the plurality of transducers converge;

a positional information acquirer that acquires positional information regarding positions of the plurality of transducers; and

a characteristic information acquirer,

the control method comprising:

operating the positional information acquirer to acquire, for a case where a point sound source is positioned at a first position at which the point sound source and the probe take predetermined relative positions, a first data group which is a distance between the first position and each of the plurality of transducers;

operating the positional information acquirer to calculate, for a case where the measurement object is the point sound source, a second data group which is a distance between the point sound source and each of the plurality of transducers, based on the electrical signal derived from the acoustic wave having actually propagated from the point sound source;

operating the positional information acquirer to calculate the positional information, based on the first data group and the second data group; and

operating the characteristic information acquirer to acquire characteristic information on the measurement object, based on the electrical signal and the positional information.

According to the present invention, the positions of a plurality of transducers can be accurately calibrated using received signals of the transducers.

Further features of the present invention will become apparent from the following description of exemplary embodiments with reference to the attached drawings.

### BRIEF DESCRIPTION OF THE DRAWINGS

FIG. 1 is a schematic diagram showing an object information acquiring apparatus;

FIG. 2 is a flow chart of acquisition of object information by an object information acquiring apparatus;

FIG. 3 is a flow chart of acquisition of calibration data;

FIG. 4 is a schematic view of a virtual point sound source and a plurality of transducers during acquisition of calibration data;

FIG. 5 is a schematic view of a point sound source and a plurality of transducers during acquisition of calibration data;

FIG. 6 is a schematic diagram of a hemispherical probe; and

FIGS. 7A and 7B show a comparison between reconstructed images before and after calibration.

### DESCRIPTION OF THE EMBODIMENTS

Hereinafter, preferred embodiments of the present invention will be described with reference to the drawings. However, it is to be understood that dimensions, materials, shapes, relative arrangements, and the like of components described below are intended to be changed as deemed appropriate in accordance with configurations and various conditions of apparatuses to which the present invention is to be applied. Therefore, the scope of the present invention is not intended to be limited to the embodiments described below.

The present invention relates to a technique for detecting an acoustic wave propagating from an object and generating and acquiring characteristic information of the inside of the object. Accordingly, the present invention can be considered an object information acquiring apparatus or a control method thereof, or an object information acquiring method and a signal processing method. The present invention can also be considered a program that causes an information processing apparatus including hardware resources such as a CPU and a memory to execute these methods or a storage medium storing the program.

The object information acquiring apparatus according to the present invention includes an apparatus utilizing a photoacoustic effect in which an acoustic wave generated inside an object by irradiating the object with light (an electromagnetic wave) is received and characteristic information of the object is acquired as image data. In this case, characteristic information refers to information on a characteristic value corresponding to each of a plurality of positions inside the object which is generated using a received signal obtained by receiving a photoacoustic wave.

Characteristic information acquired by photoacoustic measurement is a value reflecting an absorption rate of optical energy. For example, characteristic information includes a generation source of an acoustic wave generated by light irradiation, initial sound pressure inside an object, an optical energy absorption density or an absorption coefficient derived from initial sound pressure, or a concentration or an amount of substances constituting tissue. In addition, a distribution of oxygen saturation can be calculated by obtaining a concentration of oxygenated hemoglobin and a concentration of reduced hemoglobin as concentrations of substances. Furthermore, a total hemoglobin concentration, a glucose concentration, a collagen concentration, a melanin concentration, a volume fraction of fat or water, and the like are also obtained.

A two-dimensional or three-dimensional characteristic information distribution is obtained based on characteristic information at each position in the object. Distribution data maybe generated as image data. Characteristic information may be obtained as distribution information of respective positions inside the object instead of as numerical data. In other words, distribution information such as a distribution of initial sound pressure, a distribution of energy absorption density, a distribution of absorption coefficients, and a distribution of oxygen saturation may be obtained.

An acoustic wave according to the present invention is typically an ultrasonic wave and includes an elastic wave which is also referred to as a sonic wave or an acoustic wave. An electrical signal converted from an acoustic wave by a probe or the like is also referred to as an acoustic signal. However, descriptions of an ultrasonic wave or an acoustic wave in the present specification are not intended to limit wavelengths of such elastic waves. An acoustic wave generated by a photoacoustic effect is referred to as a photoacoustic wave or an optical ultrasonic wave. An electrical signal derived from a photoacoustic wave is also referred to as a photoacoustic signal.

In principle, in the following description and in the drawings, a same component will be denoted by a same reference character and a detailed explanation will be omitted. In the following description, as an example of an object information acquiring apparatus, a photoacoustic apparatus which is capable of acquiring characteristic information inside an object and generating image data will be explained.

(Apparatus Configuration)

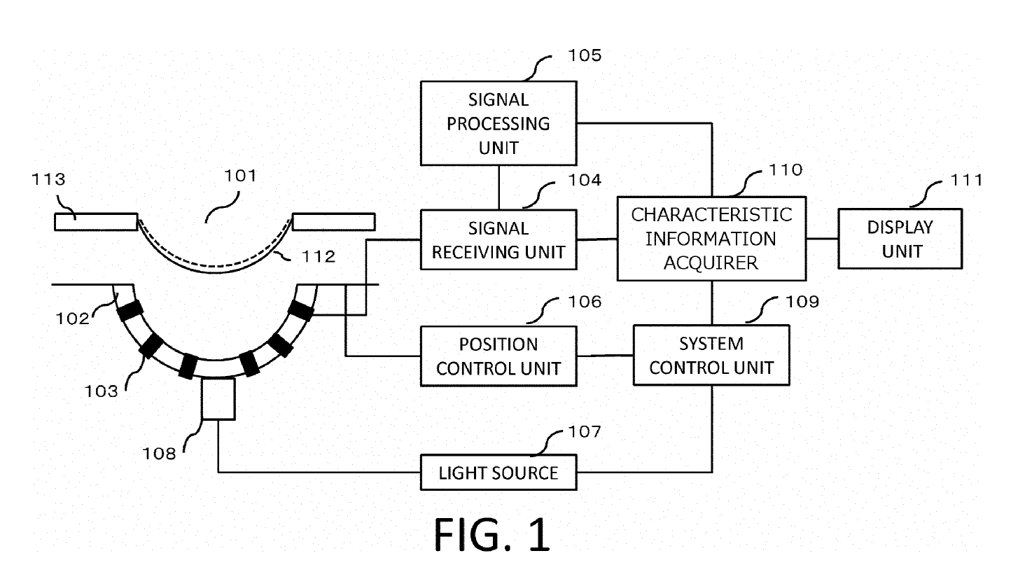

FIG. 1 is a schematic view of an apparatus configuration of an object information acquiring apparatus according to the present embodiment. The object information acquiring apparatus according to the present embodiment includes a probe 102, a plurality of transducers 103 which receive acoustic waves, a signal receiving unit 104, a signal processing unit 105, a position control unit 106, a light source 107, a system control unit 109, a characteristic information acquirer 110, and a display unit 111.

An object 101 is a measurement object. The object information acquiring apparatus according to the present invention aims to diagnose malignant tumors or vascular diseases in a living organism. Therefore, a living organism such as a human breast is assumed as a measurement object. In addition, when verifying apparatus performance or the like, a phantom which simulates characteristics of a living organism is also assumed as a measurement object. Characteristics of a living organism represent acoustic wave characteristics and optical characteristics. Furthermore, a point sound source used when calibrating a position of a transducer to be described later is also included in measurement objects.

The object 101 is held by a holding unit 112. The holding unit 112 is mounted to a mounting unit 113. A size or a shape of the holding unit 112 may be changed depending on a measurement object. In addition, measurements can be performed without mounting the holding unit 112. The holding unit 112 desirably has characteristics of transmitting light and acoustic waves. When the object 101 is a breast, a bed which supports an examinee in a face-down posture may be provided with an opening for inserting the breast, and the breast suspended downward from the opening may be measured.

The probe 102 is configured such that the plurality of transducers 103 are arranged on an inner surface of a hemispherical supporter. Examples of the transducer 103 include a conversion element such as a piezoelectric element using a piezoelectric phenomenon and a capacitance-type conversion element such as a CMUT. However, a system of a conversion element is not limited. An acoustic matching material for matching acoustic impedances is favorably arranged between the holding unit 112 and the object and between the holding unit 112 and the probe 102. Examples of the acoustic matching material include water, an ultrasonic gel, and castor oil.

Resolution can be increased in a region where directions in which receiving sensitivities of the plurality of transducers 103 are high gather. In the present specification, such a region is referred to as a high sensitivity region. Generally, sensitivity of the transducer 103 is highest in a normal direction of a receiving surface. This direction is called a directivity axis. The high sensitivity region is a region where such directivity axes converge and, in the case of a hemispherical probe such as that shown in FIG. 1, a periphery of a center of curvature of the hemisphere is the high sensitivity region.

In addition, a shape of the probe 102 is not limited to a hemispherical shape. When the directivity axes of all transducers 103 are not parallel (in other words, when at least a part of the directivity axes of the plurality of transducers 103 converge), a high sensitivity region is formed. Therefore, the probe 102 may have a shape such as a spherical crown shape, a spherical band shape, a part of an ellipsoid, and a combination of planes or curves.

The light source 107 generates pulsed light. The light source 107 receives a control signal from the system control unit 109 and generates pulsed light. A pulse with a pulse width of around 100 nsec is used to generate an acoustic wave by a photoacoustic effect. A wavelength of light is desirably around 600 to 1000 nm. As a laser type, a Nd:YAG laser, an alexandrite laser, a Ti:sa laser, and the like are used. In addition, a semiconductor laser may be used. Furthermore, a flash lamp or a light-emitting diode may be used as the light source 107. Using a variable wavelength laser or a plurality of lasers with mutually different wavelengths, measurements (such as a measurement of oxygen saturation) utilizing a difference in wavelength absorbing spectra per substance can be performed.

Laser light generated by the light source 107 is irradiated on the object 101 via an optical system 108. A lens, a prism, a mirror, an optical fiber, or the like is used as the optical system 108.

The signal receiving unit 104 includes a signal amplifier which amplifies a received signal of the plurality of transducers 103 and an AD converter which converts an analog electrical signal into a digital electrical signal. The generated digital electrical signal is input to the characteristic information acquirer 110. The signal receiving unit 104 starts operation with a synchronization signal from the optical system 108 as a trigger. When a measurement object generates photoacoustic waves, a synchronization signal regarding light source control or a signal output from an optical sensor upon detecting irradiation light is used as a trigger.

The signal processing unit 105 performs a calibration process of a transducer position based on a received signal and outputs resultant calibration data to the characteristic information acquirer 110. Alternatively, the signal processing unit 105 outputs stored calibration data to the characteristic information acquirer 110. A processing flow of the signal processing unit 105 will be described in detail later (in a flow of calibration data acquisition). The signal processing unit 105 as well as the position control unit 106, the characteristic information acquirer 110, and the like (to be described later) can be constituted by a processing circuit or an information processing apparatus. As an image processing apparatus, a PC or a work station which includes computing resources such as a CPU and a memory and which operates in accordance with instructions issued by a program is preferable. Each block may be configured as a module which operates in a same information processing apparatus or may be configured physically separately. The signal processing unit functions as a positional information acquirer according to the present invention.

The position control unit 106 changes relative positions of the plurality of transducers 103 and the object 101 by moving the probe 102. Accordingly, the high sensitivity region formed by the plurality of transducers 103 moves inside the object. As a result, a variation in sensitivity within an acquired object information image is reduced. The movement of the probe 102 may be in a two-dimensional direction or a three-dimensional direction. As a configuration for moving the probe 102, for example, an XY stage which includes a ball screw and an actuator and which moves along a programmed trajectory can be used.

The system control unit 109 exchanges information with each block included in the object information acquiring apparatus and integrally controls operation timings and operation contents of each block.

The characteristic information acquirer 110 performs image reconstruction using a received signal output from the signal receiving unit 104 and calculates characteristic information. As a method of image reconstruction, a known reconstruction method such as universal back-projection (UBP), filtered back-projection (FBP), and phasing addition is used.

The display unit 111 displays object information generated by the characteristic information acquirer 110. In addition, UIs necessary for an operator to operate the apparatus are also displayed. Any display apparatus including a liquid crystal display and a plasma display can be used as the display unit 111. The display unit 111 may be integrally provided with the object information acquiring apparatus or may be provided as a separate body.

(Point Sound Source)

A point sound source according to the present invention is positioned at a predetermined position and generates an acoustic wave at an arbitrary timing. To perform preferable calibration, a member capable of isotropically transmitting an acoustic wave is favorable. For example, a spherical member which receives light irradiation and generates a photoacoustic wave can be used. As a material of the point sound source, a material which readily increases machining accuracy of a sphere (sphericity) and which has high acoustic wave generation efficiency is favorable. For example, a member created by coating a surface of a metallic sphere with black coating material is preferable. In addition, resin, rubber, carbon, and the like can also be used. Moreover, an acoustic transducer may be used as a point sound source as long as an acoustic wave can be transmitted isotropically.

When positioning the point sound source at a predetermined position, a jig may be used which suspends and supports the point sound source with a string or a wire. Relative positions of the point sound source and the probe can be changed by moving at least one of the jig and the probe. In the case of a point sound source using a photoacoustic effect, an acoustic wave is generated by irradiating light.

(Flow of Object Information Acquisition)

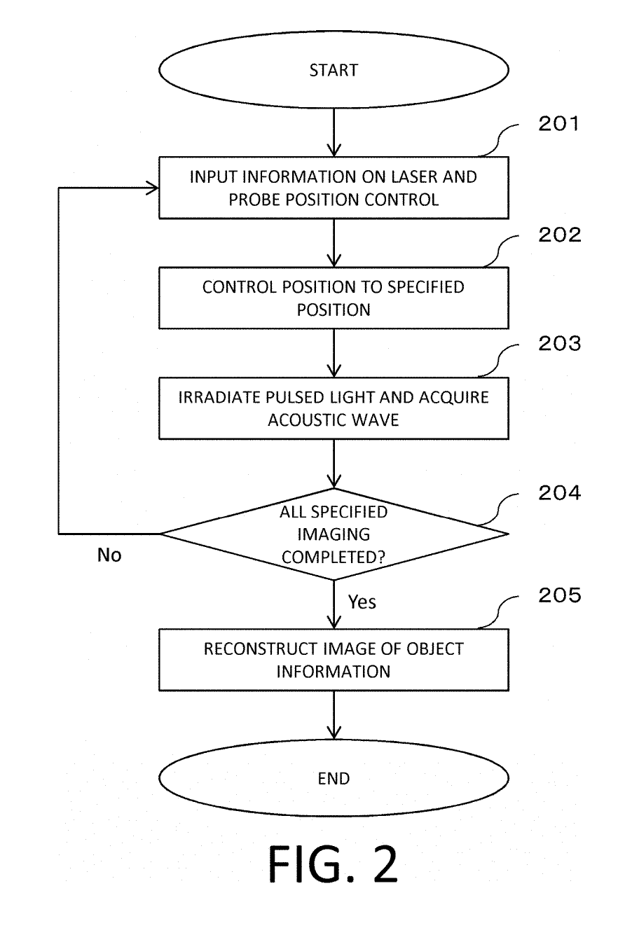

Next, a flow of object information acquisition will be described with reference to FIG. 2.

In step S201, an operator sets parameters with respect to a laser, probe position control, and the like necessary for acquiring object information.

In step S202, based on the parameters related to probe position control set in step S201, the position control unit 106 moves the probe to a specified position. When imaging at a plurality of positions is configured, the probe is moved to a first specified position.

In step S203, based on the parameters related to a laser set in step S201, pulsed light is irradiated. The pulsed light is transmitted through the optical system 108 and irradiates the object 101, and an acoustic wave is generated by the object 101. The optical system 108 transmits a synchronization signal to the signal receiving unit 104 in concurrence with the transmission of the pulsed light. Accordingly, the signal receiving unit 104 starts a receiving operation and receives an electrical signal based on an acoustic wave from the object 101. The received analog electrical signal derived from the acoustic wave is converted into an amplified digital electrical signal by the signal amplifier and the AD converter, and is output to the characteristic information acquirer 110.

In step S204, a determination is made on whether or not all imaging necessary for generating image data of a predetermined range has been completed. The predetermined range is determined according to a designation by a user or a value set in advance. When imaging has not been completed, the probe is moved to a next specified position and acquisition of an acoustic wave is repeated.

In step S205, the characteristic information acquirer 110 performs image reconstruction based on the acquired received signal and information related to the laser and probe position control, and generates image data representing object information. In typical image reconstruction, received signals of the respective transducers are added up for each unit region inside the object to obtain initial sound pressure. At this point, based on a sound velocity of a medium and a distance between a unit region and a transducer, a digital signal of an appropriate detection time is selected from the received signals. Therefore, the more accurate the distance from a unit region to a transducer, the higher the accuracy of image reconstruction. Conversely, when a position of a transducer is deviated from a design value due to accuracy during manufacturing, a signal delay created by electrical characteristics of each transducer, aging, or the like, appropriate data must be selected using calibration data. Subsequently, a distribution of initial sound pressure is obtained based on the initial sound pressure of each unit region. Object information generated in the form of a distribution of initial sound pressure, a distribution of absorption coefficients, a distribution of oxygen saturation, or the like is displayed on the display unit 111.

(Acquisition of Calibration Data Using Point Sound Source)

Calibration of a transducer position is desirably performed during assembly or regular maintenance of the apparatus. In the present invention, calibration refers to measuring a deviation of each transducer 103 from a design value, storing the measured deviation as calibration data, and using the calibration data for correction during image reconstruction. For example, calibration is performed during manufacturing, during shipping, and during routine inspections of the apparatus.

When acquiring calibration data, first, a point sound source is positioned at a specific relative position of the hemispherical probe 102. A specific relative position refers to a position at which deflection angles of polar coordinates of the plurality of transducers 103 are known in advance or a position at which directivity axes of the plurality of transducers 103 converge. In the case of the hemispherical probe 102, a specific relative position is a point of the center of curvature.

When an acoustic wave is generated by the point sound source, the plurality of transducers 103 receive the acoustic wave propagating in a medium and output a received signal. In addition, by detecting a component derived from the point sound source based on the received signal, the signal processing unit 105 calculates a distance from the point sound source to each of the plurality of transducers 103. Examples of a distance calculation method include a method of detecting a rise in intensity of a time-sequential received signal and a method of detecting intensity exceeding a predetermined threshold. The distance can be calculated using a time which elapses between the generation of an acoustic wave and the detection of a component derived from the point sound source and a sound velocity of a medium (for example, an acoustic matching material) of the acoustic wave.

Calibration data can be acquired based on the distance information of each transducer. The calibration data is used for each transducer when performing image reconstruction based on a received signal. By using the calibration data, since a distance between a unit region (a pixel or a voxel) that is a reconstruction object and a transducer can be accurately acquired, optimal data can be selected from a digital signal in a time series.

The calibration data is stored in a memory or the like in an arbitrary format. For example, let us assume that information on a designed position of each transducer when the transducer is at a home position is stored as a coordinate value in an XYZ coordinate system or a polar coordinate system set to the apparatus. In this case, the calibration data is stored as an amount of deviation from a design value. Alternatively, a coordinate value on a memory may be overwritten. Alternatively, an amount of deviation or a coordinate value may be subjected to version control together with a time and date of calibration. Alternatively, an actually-measured coordinate value in a coordinate system of each transducer may be stored.

However, a point sound source cannot be readily arranged at the point of the center of curvature of the probe 102. While a method of positioning the point sound source involves the use of a jig, it is difficult to determine position accuracy. As a result, resolution of a reconstructed image declines. In consideration thereof, in the present invention, a position of the point sound source is acquired using received signals of the plurality of transducers 103 as described above. The position control unit 106 changes relative positions of the point sound source and the probe 102 based on the positional information, and moves the point sound source to the point of the center of curvature. Accordingly, the point sound source can be positioned at a desirable position.

(Flow of Acquisition of Calibration Data of Transducer Position)

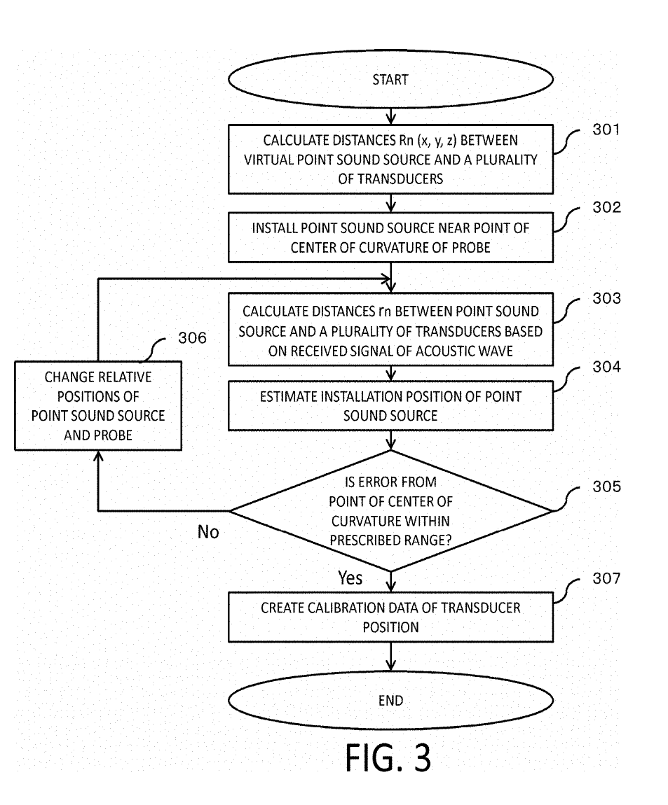

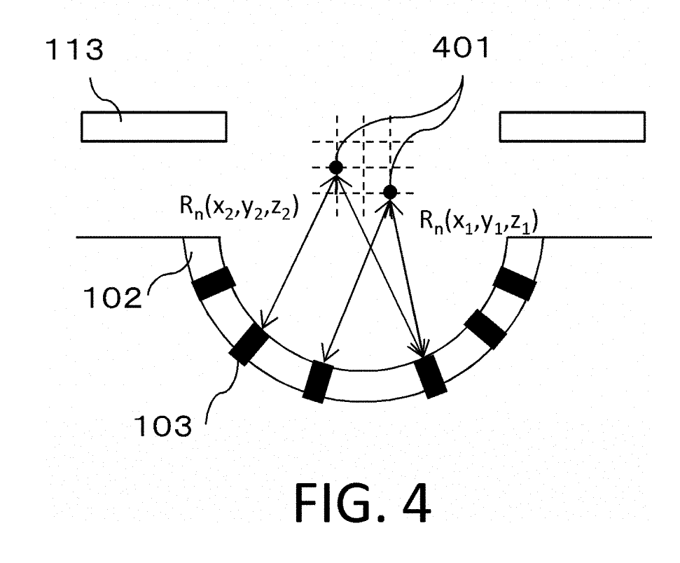

Next, a flow of acquisition of calibration data of a transducer position will be described with reference to FIG. 3. In this case, FIG. 4 shows a situation of a simulation which assumes that a virtual point sound source 401 has been arranged at a given position (x, y, z) near a position of the center of curvature of the hemispherical probe 102.

In step S301, distances Rₙ (x, y, z) between the virtual point sound source 401 and the plurality of transducers 103 when assuming a state shown in FIG. 4 are calculated. n ranges from 1 to N, where N represents the number of the plurality of transducers 103. Mechanical design values (in other words, transducer positional information prior to calibration) are used for the positions of the plurality of transducers 103 when calculating these distances. (x, y, z) is changed near the position of the center of curvature to calculate each distance Rₙ (x, y, z). Estimation accuracy of a position of the point sound source is improved by narrowing pitches of the plurality of positions (x, y, z) and expanding a range.

The distance Rₙ (x, y, z) may be calculated and stored or may be calculated as necessary when performing the calculation of step S304 to be described later. A distance between each transducer and the virtual point sound source corresponds to a first data group according to the present invention. The first data group may be stored in advance in a memory prior to calibration. In addition, in the case of calibration for reducing an effect of deformation due to aging of the probe, a new first data group may be acquired based on positions of the respective transducers acquired by a previous calibration process.

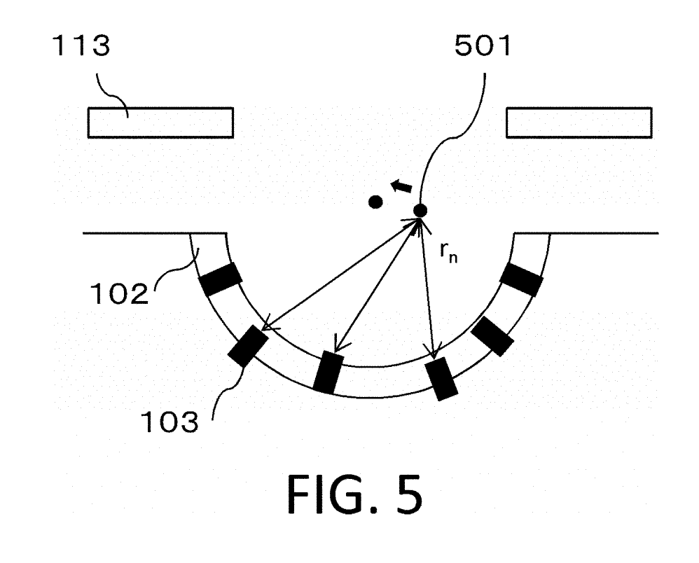

In step S302, as shown in FIG. 5, a point sound source 501 is positioned near the point of the center of curvature of the hemispherical probe 102 in the actual object information acquiring apparatus.

In step S303, an acoustic wave is propagated from the actual point sound source 501. As shown in FIG. 5, each of the plurality of transducers 103 receives the acoustic wave and outputs a received signal. Using the received signals, the characteristic information acquirer 110 calculates distances rₙ from the point sound source 501 to the plurality of transducers 103. n ranges from 1 to N, where N represents the number of the plurality of transducers 103. In this case, the distances rₙ are calculated by detecting a rise of the received signals. In doing so, a spherical diameter of the point sound source 501 is favorably taken into consideration. In addition, an amount of delay with respect to reception by the plurality of transducers 103 and the signal receiving unit 104 is also taken into consideration. Furthermore, the received signals may be subjected to an interpolation process to improve accuracy of the calculated distances. Information representing a distance between an actual point sound source and each transducer corresponds to a second data group according to the present invention.

In step S304, the characteristic information acquirer 110 calculates (x, y, z) which minimizes a square of a difference between the distance Rₙ (x, y, z) between the virtual point sound source 401 and each transducer 103 and the distance rₙ between the point sound source 501 and each transducer 103. In addition, the position is adopted as an estimation result of a position of the point sound source 501. In other words, (x, y, z) which minimizes d (x, y, z) in Expression (1) below is calculated.

$$\begin{matrix}[ Math . 1 ] & \\ d ( x , y , z ) = {\sum }_{n = 1}^{N} {( {R}_{n} ( x , y , z ) - {r}_{n} )}^{2} & ( 1 )\end{matrix}$$

In step S305, based on the estimated position of the point sound source 501, a determination is made on whether or not the point sound source 501 is arranged within a predetermined error from the point of the center of curvature. When the point sound source 501 is separated from the center by the predetermined error or more, a transition is made to step S306. When the error is smaller than the predetermined error, a transition is made to step S307.

In step S306, as shown in FIG. 5, relative positions of the point sound source 501 and the probe 102 are changed by an amount corresponding to the error from the position of the point sound source 501 estimated in step S304 to the point of the center of curvature. The relative positions maybe changed by moving the point sound source 501 or by moving the position of the probe 102.

In step S307, calibration data of a transducer position is created by adopting the distances rₙ from the point sound source 501 to the plurality of transducers 103 as the distances from the point of the center of curvature of the probe 102 to the plurality of transducers 103, and the calibration data is stored.

The point sound source used to acquire the calibration data is appropriately arranged based on positional information calculated using the first data group and the second data group according to the present invention. Therefore, by correcting an error in a transducer position using the calibration data obtained by the method described above and performing image reconstruction, object information with high resolution can be generated. In addition, by calibrating a transducer position using received signals of the plurality of transducers 103 in this manner, a variation in characteristics of a reception circuit and the like can be corrected in addition to correcting a physical position of a transducer.

### EXAMPLES

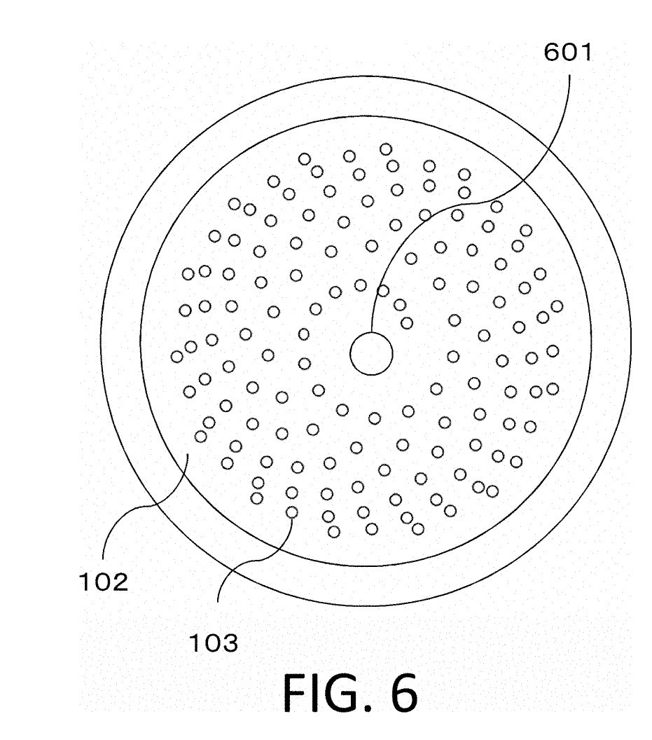

Hereinafter, more detailed examples will be described. The probe 102 is a member in which 512 transducers 103 are arranged on an inner surface of a hemispherical supporter. The plurality of transducers 103 are assumed to be transducers with a diameter of 1.5 mm. FIG. 6 is a schematic plan view of the probe. The plurality of transducers 103 form a three-dimensional spiral on the hemisphere. A coordinate system of the arrangement of transducers is defined by a radius r, a polar angle θ, and an azimuth φ of a polar coordinate system centered on the point of the center of curvature and by an orthogonal coordinate system x, y, z.

In this case, a distance between each transducer and the point of the center of curvature is assumed to randomly have an error within a range of ±0.1 mm from the mechanical design value. Therefore, an error within a range of ±0.1 mm is also included in a direction of the radius r of the polar coordinate system. This corresponds to the distance between each transducer and the point of the center of curvature having an error of ±0.1 mm from a design value. Moreover, when the probe 102 is scannable, a case where the probe 102 is directly beneath the opening of the bed is assumed to be a home position, and calibration using the point sound source is performed at this position.

### COMPARATIVE EXAMPLE

In the present example, a pulse is irradiated from a light irradiating unit 601 in a state where a spherical measurement object with a diameter of 0.1 mm is set near the point of the center of curvature. A sampling frequency of the signal receiving unit is assumed to be 40 MHz. A temporal axis of a photoacoustic wave received by each transducer is converted into a distance based on a sound velocity of a medium between the measurement object and each transducer. In addition, based on a mechanical design value (in other words, a position coordinate of each transducer prior to calibration) of an arrangement of the transducers, the characteristic information acquirer reconstructs a distribution of initial sound pressure by a UBP method in which a received acoustic wave is back-projected.

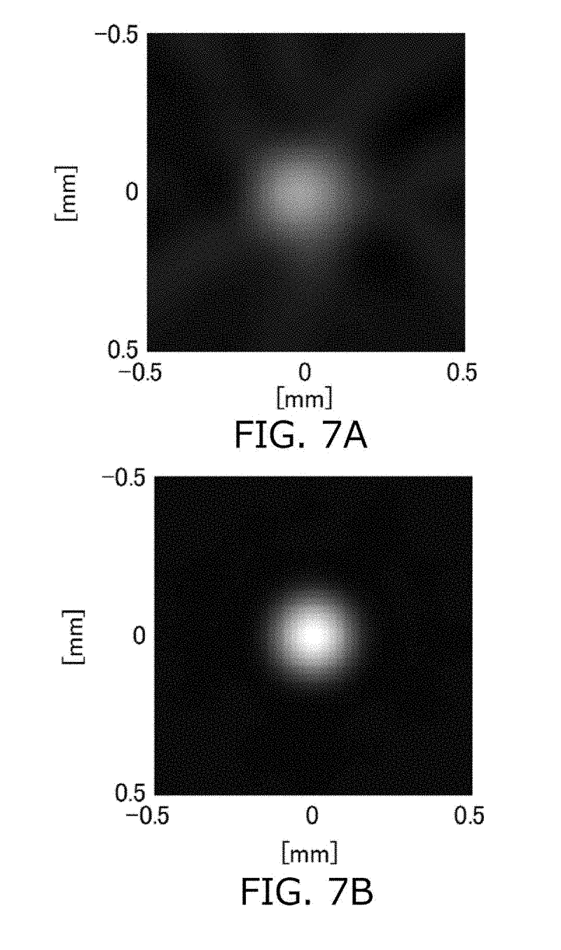

FIG. 7A represents a reconstructed point sound source image. A half-value width of the point sound source image is 0.25 mm. This result includes a decline in resolution attributable to the fact that the distance between each transducer and the point of the center of curvature has an error of ±0.1 mm from the mechanical design value.

### Method and Effect of Present Invention

This decline in resolution is improved by creating calibration data based on positional information of the transducers (probe) and using the calibration data for image reconstruction. A point sound source with a diameter of 1.5 mm is used to calibrate a transducer position. Subsequently, in accordance with the flow of acquisition of calibration data of a transducer position described above, the point sound source is moved to the point of the center of curvature of the hemispherical probe. A sampling frequency of the signal receiving unit in this case is assumed to be 40 MHz in a similar manner to the comparative example described above. In addition, a pitch of (x, y, z) when calculating Rₙ (x, y, z) is set to 0.01 mm.

Under the conditions described above, a distance between the point of the center of curvature and each transducer is calculated based on a received signal of each transducer. Specifically, a distance from a position assumed to be the point of the center of curvature and each transducer is calculated based on a propagation time that can be acquired from a rise position of a received signal and a sound velocity of a medium between the point sound source and each transducer. When calculating distances, favorably, a spherical diameter of the point sound source, response delay characteristics of each transducer, and an offset amount or a delay amount related to sampling of the signal receiving unit are taken into consideration. Accordingly, accuracy of calculation of distances improves.

The distance calculated from the received signal is adopted as a radius r of a polar coordinate system of each transducer, and an orthogonal coordinate system x, y, z is also corrected based on the radius r, a polar angle θ, and an azimuth φ. Accordingly, calibration data of a transducer position can be acquired. The calibration data may be stored as a difference from a design value.

Using the calibration data of a transducer position, a distribution of initial sound pressure of a spherical measurement object with a diameter of 0.1 mm which is the same as in the comparative example is reconstructed by the UBP method. FIG. 7B represents a calculated point sound source image. A half-value width of the point sound source image is 0.19 mm. This result confirms that resolution has been improved and that calibration is effective.

### Other Embodiments

The present invention can also be achieved by supplying a program that realizes one or more functions of the embodiment described above to a system or an apparatus via a network or a storage medium and having one or more processors in a computer in the system or the apparatus read and execute the program. Alternatively, the present invention can also be achieved by a circuit (for example, an ASIC) which realizes one or more functions.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-246618, filed on Dec. 17, 2015, which is hereby incorporated by reference herein in its entirety.

What is claimed is:

1. An object information acquiring apparatus, comprising:
a plurality of transducers that receive an acoustic wave propagating from a measurement object irradiated with light and that convert the acoustic wave into an electrical signal;
a probe on which the plurality of transducers are arranged so that directivity axes of at least a part of the plurality of transducers converge;
a positional information acquirer that acquires positional information regarding positions of the plurality of transducers; and
a characteristic information acquirer that acquires characteristic information on the measurement object based on the electrical signal and the positional information, wherein
the positional information acquirer:
acquires, for a case where a point sound source is positioned at a first position at which the point sound source and the probe take predetermined relative positions, a first data group which is a distance between the first position and each of the plurality of transducers;
calculates, for a case where the measurement object is the point sound source, a second data group which is a distance between the point sound source and each of the plurality of transducers based on the electrical signal derived from the acoustic wave having actually propagated from the point sound source; and
calculates the positional information based on the first data group and the second data group.

2. The object information acquiring apparatus according to claim 1, wherein
the characteristic information acquirer calibrates the electrical signal output by each of the plurality of transducers based on a deviation of a position of each of the plurality of transducers from a design value.

3. The object information acquiring apparatus according to claim 2, wherein
the positional information acquirer moves the point sound source to the first position based on the positional information, and acquires the second data group related to the point sound source at the first position, and
the characteristic information acquirer uses the second data group related to the point sound source at the first position to implement the calibration.

4. The object information acquiring apparatus according to claim 3, further comprising
a jig that supports the point sound source, wherein
the positional information acquirer moves the point sound source by changing relative positions of the jig and the probe.

5. The object information acquiring apparatus according to claim 2, wherein
the characteristic information acquirer acquires, for each unit region of the measurement object, characteristic information of the unit region by selecting, based on a sound velocity of a medium of the acoustic wave and distances between the plurality of transducers and the unit region, data corresponding to the unit region from the electrical signal output by the plurality of transducers, and adding up the data, and
the distances between the plurality of transducers and the unit region are calibrated, based on the second data group.

6. The object information acquiring apparatus according to claim 1, wherein
the first position is a position where directivity axes of the plurality of transducers converge.

7. The object information acquiring apparatus according to claim 6, wherein
the probe is a hemispherical member having an inner surface on which the plurality of transducers are arranged, and
the first position is a point of a center of curvature of the hemispherical probe.

8. The object information acquiring apparatus according to claim 1, wherein
the point sound source is a spherical member that generates an acoustic wave when irradiated with light or an acoustic transducer that transmits an acoustic wave.

9. A control method for an object information acquiring apparatus including:
a plurality of transducers that receive an acoustic wave propagating from a measurement object irradiated with light and that convert the acoustic wave into an electrical signal;
a probe on which the plurality of transducers are arranged so that directivity axes of at least a part of the plurality of transducers converge;
a positional information acquirer that acquires positional information regarding positions of the plurality of transducers; and
a characteristic information acquirer,
the control method comprising:
operating the positional information acquirer to acquire, for a case where a point sound source is positioned at a first position at which the point sound source and the probe take predetermined relative positions, a first data group which is a distance between the first position and each of the plurality of transducers;
operating the positional information acquirer to calculate, for a case where the measurement object is the point sound source, a second data group which is a distance between the point sound source and each of the plurality of transducers, based on the electrical signal derived from the acoustic wave having actually propagated from the point sound source;
operating the positional information acquirer to calculate the positional information, based on the first data group and the second data group; and
operating the characteristic information acquirer to acquire characteristic information on the measurement object, based on the electrical signal and the positional information.
